(19) United States
(12) Patent Application Publication
(10) Pub. No.: US 2020/0264489 A1
(43) Pub. Date: Aug. 20, 2020

(54) ELECTRONIC MIRROR WITH AUTOMATIC LUMINANCE AND AUTOMATIC DIMMING CONTROL SYSTEM

(71) Applicant: VISTEON GLOBAL TECHNOLOGIES, INC., Van Buren Township, MI (US)

(72) Inventor: Paul Fredrick Luther Weindorf, Novi, MI (US)

(73) Assignee: VISTEON GLOBAL TECHNOLOGIES, INC., Van Buren Township, MI (US)

(21) Appl. No.: 16/789,683

(22) Filed: Feb. 13, 2020

Related U.S. Application Data
(60) Provisional application No. 62/805,488, filed on Feb. 14, 2019.

(51) Int. Cl. G02F 1/19; G02F 1/01; G01J 1/42; B60R 1/04

(52) U.S. Cl. CPC G02F 1/19; B60R 1/04; G01J 1/4204; G02F 1/0123

(57) ABSTRACT

An electronic mirror includes an electronic lens assembly, a light sensor, an ambient light sensor and a control circuit. The electronic lens assembly is configured to reflect a light at a reflectance rate in response to a reflectance value. The light sensor is configured to generate an intensity value by logarithmic sensing the light proximate the electronic lens assembly. The ambient light sensor is configured to generate an ambient intensity value by logarithmic sensing an ambient light. The control circuit is configured to generate the reflectance value in response to the ambient intensity value and the intensity value while in a mirror mode. The refection value adjusts the reflectance rate of the electronic lens assembly with a negative fractional power of the intensity value.

### CROSS-REFERENCE TO RELATED APPLICATIONS

This application claims the benefit of U.S. Provisional Application No. 62/805,488, filed Feb. 14, 2019, which is hereby incorporated by reference in its entirety.

### BACKGROUND

Vehicles are equipped with rear-view mirrors that allow drivers to see the environment behind the vehicles without turning their heads around. Automatic dimming rear-view mirrors utilize a rear light sensor to measure an intensity of trailing headlights and a forward light sensor to measure an intensity of an ambient light to control the dimming. As the trailing headlight intensity changes, an electrochromic element within the automatic dimming rear-view mirrors changes an attenuation level of the trailing headlights reflected by the rear-view mirror. The attenuation adjustment of the rear-view mirror is based on an intensity of the ambient light. In low ambient conditions, the attenuation rapidly adjusts to changes in the trailing headlights. In higher ambient conditions, the attenuation slowly adjusts to the changes in the trailing headlights. The attenuation does not consider a human eye adaptation to changes in the ambient light and the trailing headlights.

### SUMMARY

An electronic mirror is provided herein. The electronic mirror includes an electronic lens assembly, a light sensor, an ambient light sensor and a control circuit. The electronic lens assembly is configured to reflect a light at a reflectance rate in response to a reflectance value. The light sensor is configured to generate an intensity value by logarithmic sensing the light proximate the electronic lens assembly. The ambient light sensor is configured to generate an ambient intensity value by logarithmic sensing an ambient light. The control circuit is configured to generate the reflectance value in response to the ambient intensity value and the intensity value while in a mirror mode. The refection value adjusts the reflectance rate of the electronic lens assembly with a negative fractional power of the intensity value.

An electronic display mirror is provided herein. The electronic display mirror includes a housing, an electronic lens assembly, a rear light sensor, an ambient light sensor and a control circuit. The housing is attachable to a vehicle, and has an open side. The electronic lens assembly is disposed in the housing facing the open side, and is configured to reflect a rear light incident on the open side at a reflectance rate in response to a reflectance value. The rear light sensor is attached to the housing facing the open side, and is configured to generate a rear intensity value by logarithmic sensing the rear light proximate the electronic lens assembly. The ambient light sensor is attached to the housing facing away from the open side, and is configured to generate an ambient intensity value by logarithmic sensing an ambient light. The control circuit is disposed in the housing, and is configured to generate the reflectance value in response to the ambient intensity value and the rear intensity value. The reflectance value adjusts the reflectance rate of the electronic lens assembly with a negative fractional power of the intensity value.

A non-transitory computer readable medium on which is recorded instructions, executable by a processor, for controlled dimming of an electronic mirror, wherein execution of the instructions causes the processor to: receive an intensity value from a light sensor, wherein the light sensor is configured to generate the intensity value by logarithmic sensing a light; receive an ambient intensity value from an ambient light sensor, wherein the ambient light sensor is configured to generate the ambient intensity value by logarithmic sensing an ambient light; generate a reflectance value in response to the ambient intensity value and the intensity value while in a mirror mode; and transfer the reflectance value to an electronic lens assembly, wherein the reflectance value adjusts a reflectance rate of the electronic lens assembly with a negative fractional power of the intensity value.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

Further details, features and advantages of designs of the disclosure result from the following description of embodiment examples in reference to the associated drawings.

FIG. 1 illustrates a context of a system.

FIG. 2 illustrates an exploded view of an electronic display mirror in accordance with one or more embodiments of the present disclosure.

FIG. 3 illustrates a front perspective view of the electronic display mirror in accordance with one or more embodiments of the present disclosure.

FIG. 4 illustrates a summary table of an exemplary mirror reflectance rate range in accordance with one or more embodiments of the present disclosure.

FIG. 5 illustrates a graphical plot of the data of the table of FIG. 4 in accordance with one or more embodiments of present disclosure.

FIG. 6 illustrates a graph of the reflection function in accordance with one or more embodiments of the present disclosure.

FIG. 7 illustrates a logarithmic scale graph of FIG. 6 in accordance with one or more embodiments of the present disclosure.

FIG. 8 illustrates a graph of the reflectance function under various ambient intensities in accordance with one or more embodiments of the present disclosure.

FIG. 9 illustrates a block diagram of an automatic dimming control system in accordance with one or more embodiments of the present disclosure.

FIG. 10 illustrates a graph or reflectance rates for various forward-looking Lux values in accordance with one or more embodiments of the present disclosure.

FIG. 11 illustrates a top view of a reflection view in accordance with one or more embodiments of the present disclosure.

FIG. 12 illustrates a left side view of the reflection view in accordance with one or more embodiments of the present disclosure.

FIG. 13 illustrates a cutaway view of a frustum for a rear light sensor in accordance with one or more embodiments of the present disclosure.

FIG. 14 illustrates an exemplary flowchart of a method of an auto dimming control system in accordance with one or more embodiments of the present disclosure.

### DETAILED DESCRIPTION

Recurring features are marked with identical reference numerals in the figures. An electronic display mirror is generally attached to an interior surface of a vehicle, such as a front windshield, a roof, or a dashboard. In some embodiments, the electronic display mirror may be attached to an exterior surface of the vehicle, such as a driver-side door or a passenger-side door.

According to one or more embodiments, a device may implement the electronic display mirror to provide automatically variable reflection of trailing headlights to a user. A reflection rate of the electronic display mirror may be based on both an intensity of the trailing headlights and an intensity of ambient light seen by the user.

According to one or more embodiments, a method may be implemented to allow the user to adjust a “bias” preference for the automatic reflection function of the electronic display mirror. The bias adjustment may be made through implementation of a negative fractional power function. The user bias may be in any form of an input, such as, but not limited to a potentiometer, a capacitive touch screen input on the electronic display mirror, or a remote input such as a steering wheel control (not shown).

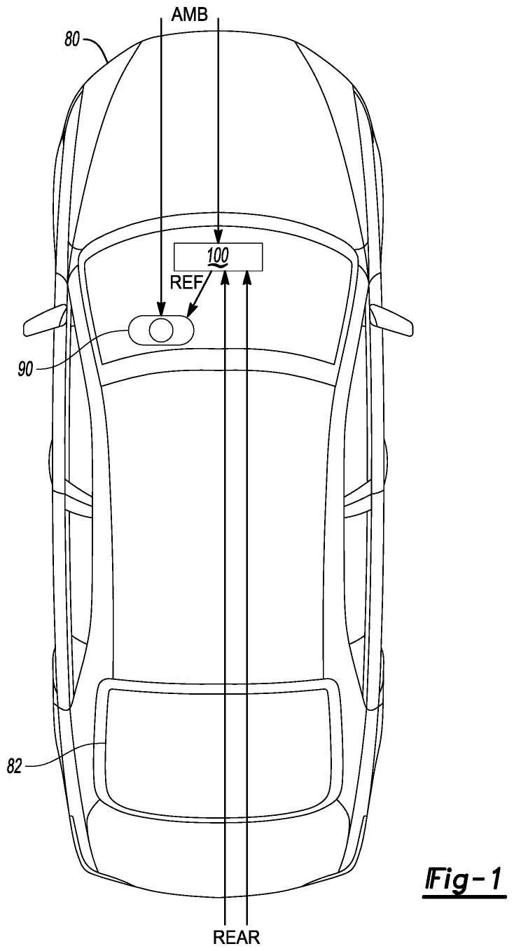

FIG. 1 illustrates a context of a system. The system generally comprises a vehicle 80, a rear windshield 82, a user (or person) 90 and an electronic display mirror 100. An ambient light signal (e.g., AMB) may be received by the electronic display mirror 100 and a front (e.g., eyes) of the user 90. A rear light signal (e.g., REAR) may be received by the electronic display mirror 100 and a back of the user 90 through the rear windshield 82. A reflected light signal (e.g., REF) may be a reflection of the rear light signal REAR from the electronic display mirror 100 toward the user 90. Under various conditions, the rear light signal REAR may be generated by headlights on one or more other vehicles traveling on the same road in the same direction as the vehicle 80 and located behind the vehicle 80. As illustrated, the user 90 may be looking in a forward direction and so sees the ambient light signal AMB and the reflected light signal REF.

The vehicle 80 may include mobile vehicles such as automobiles, trucks, motorcycles, boats, trains and/or aircraft. In some embodiments, the vehicle 80 may be a stationary object. The stationary objects may include, but are not limited to, billboards, kiosks and/or marquees. Other types of vehicles 80 may be implemented to meet the design criteria of a particular application.

The electronic display mirror 100 is generally configured in a mirror (or first) mode to reflect the rear light signal REAR arriving from a rear (or first) direction of the vehicle 80 at a reflectance rate in response to a reflectance value. A rear light sensor of the electronic display mirror 100 may face the rear direction. The rear light sensor may be configured to generate a rear intensity value by logarithmic sensing the rear light signal REAR proximate the electronic display mirror 100. An ambient light sensor of the electronic display mirror 100 may face away from the rear direction (e.g., face a second direction). The ambient light sensor may be configured to generate an ambient intensity value by logarithmic sensing the ambient light signal AMB. A control circuit of the electronic display mirror 100 may be configured to generate the reflectance value in response to the ambient intensity value and the rear intensity value. The refection value generally adjusts the reflectance rate of the rear light signal REAR by the electronic display mirror 100 with a negative fractional power of the rear intensity value. The reflected light signal REF may be viewed by the user 90 at an intensity level that is based on both a brightness of the rear light signal REAR and a brightness of the ambient light signal AMB.

The electronic display mirror 100 is generally configured in a display (or second) mode to generate and present visual information in the first direction to the user 90 at a variable luminance rate (or level). In the display mode, the electronic display mirror 100 may utilize the same rear light sensor and the same ambient light sensor to provide automatic luminance control of the visual information. The control circuit may be configured to generate a luminance value in response to the ambient intensity value and the rear intensity value. The luminance value generally adjusts the luminance with a positive fractional power of the rear intensity value.

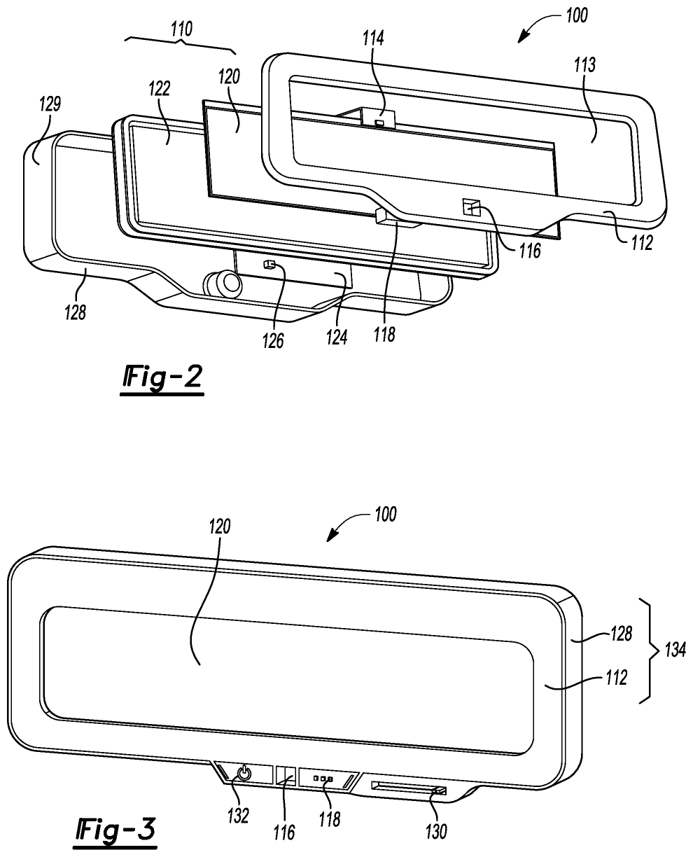

FIG. 2 illustrates an exploded view of the electronic display mirror 100 in accordance with one or more embodiments of the present disclosure. The electronic display mirror 100 may include a front bezel 112 that defines an open side (or aperture) 113, a flex element 114, a rear light sensor 116, a button 118, an electronic lens assembly 120, a display 122, a printed wire board 124, at least one switch 126, a rear cover 128 and an ambient light sensor 129. A combination of the electronic lens assembly 120 and the display 122 may form an electronic mirror 110.

The electronic mirror 110 may implement an electronically-variable reflection rate mirror. The electronic mirror 110 is generally operational to reflect a percentage of the rear light signal REAR to form the reflected light signal REF based on an electrical signal. The electronic mirror 110 may include “active mirror” technology. According to one or more embodiments, the electronic mirror 110 disposed in the electronic display mirror 100 may include an attribute that, as the reflection rate is reduced, the display transmission increases.

The front bezel 112 may include the open side 113, and one or more openings for other elements for switches and/or sensors.

The flex element 114 may implement an electrical interface. The flex element 114 is generally operational to operate (e.g., energize) the one or more components in the electronic display mirror 100. In completed assemblies, the flex element 114 may electrically connect to the electronic lens assembly 120.

The rear light sensor 116 may implement a visible light sensor. The rear light sensor 116 is generally operational to generate a rear intensity value by logarithmically sensing the rear light signal REAR. The rear light sensor 116 may be mounted on and connected to the printed wire board 124. The rear light sensor 116 generally engages an opening in the front bezel 112. In various embodiments, the rear light sensor 116 may operate over a dynamic range of five decades of illuminance.

The button 118 may be disposed on and connected to the printed wire board 124. The button 118 may be positioned to align with an opening in the front bezel 112. The button 118 may have one or more functions and may be configured as one or more buttons 118.

The electronic lens assembly 120 may be configured as an electronically variable optical device. The electronic lens assembly 120 is generally operational to provide an active system to control the mirror reflection rate (or level). An example of the electronic lens assembly 120 may be an optical device described in U.S. Pat. No. 9,304,333. In the mirror mode, the electronic lens assembly 120 may be controlled to vary the reflection rate based on the rear light intensity and the ambient light intensity. In the display mode, the electronic lens assembly 120 may be controlled to provide a maximum transmission rate of the visual information. The maximum controlled transmission rate may occur at a minimum controlled reflection rate.

The display 122 may implement a standard display with a variable luminance capability. The display 122 is generally operational to provide visual information to the user 90. In some embodiments, the display 122 may be a thin-film-transistor display with an active backlight. In other embodiments, the display 122 may be a liquid crystal display with the active backlight. Other display technologies may be implemented to meet the design criteria of a particular application. In the mirror mode, a brightness of the display 122 may be set to a minimum controlled value. In the display mode, the brightness of the visual information presented by the display 122 may be controlled based on the rear light intensity and the ambient light intensity.

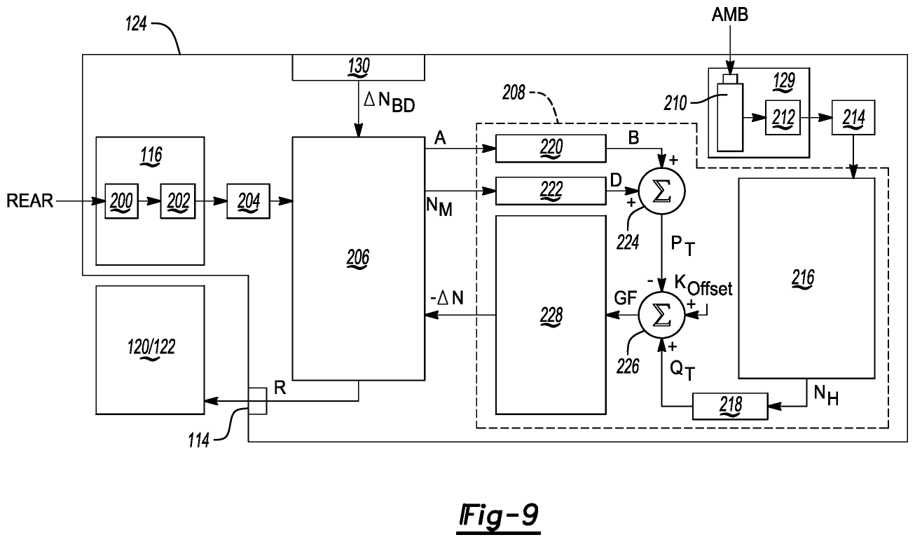

The printed wire board 124 may implement a control circuit (see FIG. 9). The printed wire board 124 may include one or more sensors, a processor, and memory, as well as other components, such as a display driver, and a battery. The printed wire board 124 may also be used to provide mechanical support for the rear light sensor 116, the button 118, the least one switch 126 and the ambient light sensor 129.

The at least one switch 126 may be configured to control one or more components of the electronic display mirror 100. The at least one switch 126 may be mounted on and connected to the printed wire board 124. The at least one switch 126 may be positioned to be accessible to the user 90 through at least one opening in the front bezel 112.

The rear cover 128 may be configured to receive one or more components of the electronic display mirror 100. The rear cover 128 may provide protection for the front windshield facing side of the electronic display mirror 100.

The ambient light sensor 129 may implement a visible light sensor. The ambient light sensor 129 is generally operational to generate an ambient intensity value by logarithmically sensing the ambient light signal AMB. The ambient light sensor 129 may be mounted on and connected to the printed wire board 124. The ambient light sensor 129 is generally aligned with an opening in the rear cover 128. In various embodiments, the ambient light sensor 129 may operate over a dynamic range of five decades of illuminance.

FIG. 3 illustrates a front perspective view of the electronic display mirror 100 in accordance with one or more embodiments of the present disclosure. The electronic display mirror 100 may further comprise a slide control 130 and a power switch 132. A combination of the rear cover 128 and the front bezel 112 may form a housing 134.

The slide control 130 may implement a linear sensor (or bias sensor). The slide control 130 may be operational to receive a manual input from the user 90 to control a bias setting of the electronic display mirror 100. The slide control 130 may be mounted on and connected to the printed wire board 124. The slide control 130 may be positioned to engage an opening in the front bezel 112 and/or the housing 134.

The power switch 132 may implement a push button switch. The power switch 132 is generally operational to enable and disable the reflection function of the electronic display mirror 100. The power switch 132 may be mounted on and connected to the printed wire board 124. The power switch 132 is generally aligned with an opening in the front bezel 112 and/or the housing 134.

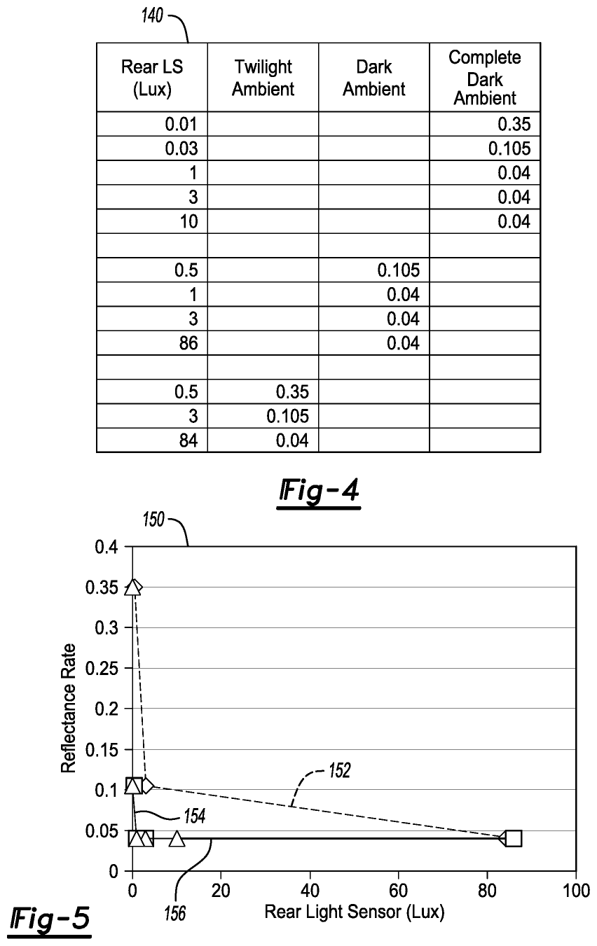

FIG. 4 illustrates a summary table 140 of an exemplary mirror reflectance rate range in accordance with one or more embodiments of the present disclosure. The summary table generally presents the mirror reflectance rate under various ambient conditions and over a variety of rear light luminous flux per unit area (Lux). The mirror reflection rate in a range of 0.04 to 0.35 may exist under a twilight ambient condition (second from the left column). A reflection rate range of 0.04 to 0.15 may exist under a dark ambient condition (third from the left column). The mirror reflection rate may range from 0.04 to 0.35 under a completely dark ambient condition (right column).

FIG. 5 illustrates a graphical representation 150 of the data shown in the table of FIG. 4 in accordance with one or more embodiments of the present disclosure. The x-axis may represent the light intensity detected by the rear light sensor 116. The y-axis may represent the reflectance rate (or level) of the electronic lens assembly 120.

A curve 152 may show the reflection rate under the twilight ambient condition. A curve 154 may show the reflection rate under the dark ambient condition. A curve 156 may show the reflection rate under the completely dark ambient condition. The graph 150 may illustrate that the reflectance rate function is steeper in the lower rear light sensor luminance flux range. In general, the eye of the user 90 may prefer a higher contrast ratio under dim lighting conditions, which is akin to the user 90 preferring more reflectance under dark, nighttime conditions.

According to one or more embodiments, equation 1 may satisfy all the user preferences for the automatic dimming function in the mirror mode as follows:

R=B_{O}(LS_{REAR})^{-C}, (1)
where: R=reflectance value; B_{O}=offset constant; LS_{REAR}=rear light sensor value in Lux; and C=power constant (e.g., a slope of the power function in logarithmic coordinates).

In equation 1, the reflectance is generally a power function with a fractional power C that is negative. According to one or more embodiments, the negative fractional power is a constant.

In the display mode, a positive fractional power C may be used in automatic luminance control systems per equation 2 as follows:

ESL=B_{0D}(DBL)^{C}, (2)
where: ESL=Emitted Symbol Luminance in candela per square meter (e.g., cd/m²); B_{OD}=offset constant (display mode); DBL=Display Background Luminance in cd/m² proportional to the display ambient light sensor value; and C=power constant.

According to one or more embodiments, for a dynamic reflectance range of 0.04 to 0.35 for rear light sensor values LS_{REAR} of 1 to 100 Lux, the offset constant Bo may be determined by equation 3 as follows:

$${B}_{0} = \frac{0.35}{{1}^{- C}} = 0.35 , \qquad ( 3 )$$

where 0.35 may be an exemplary maximum offset value.

According to one or more embodiments, the power constant C may be determined by equation 4 as follows:

$$C = - \frac{log ( \frac{0.04}{0.35} )}{log ( 100 )} = 0.471 \qquad ( 4 )$$

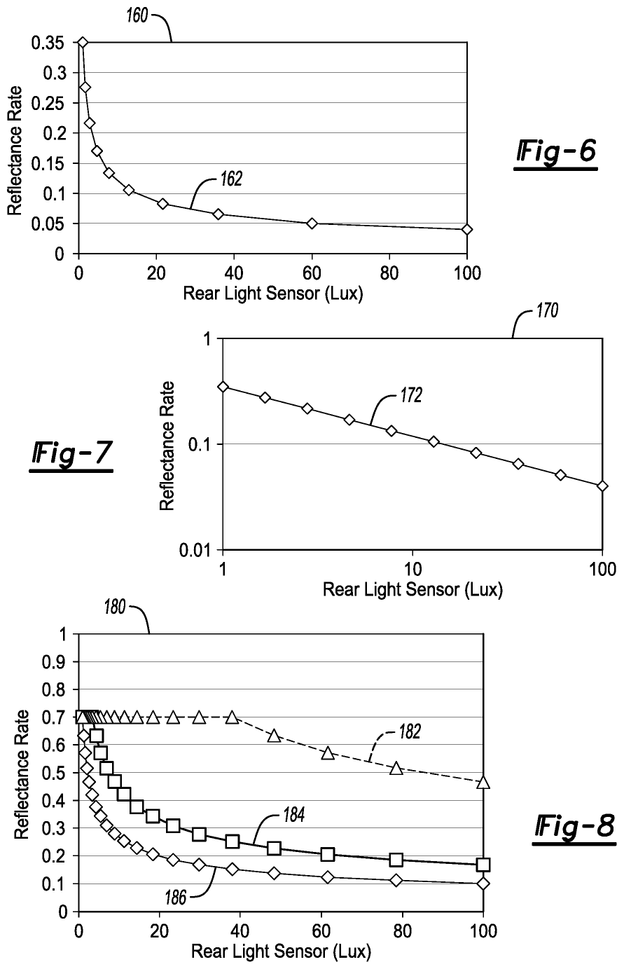

FIG. 6 illustrates a graph 160 of the reflection function in accordance with one or more embodiments of the present disclosure. The x-axis may represent the light intensity detected by the rear light sensor 116. The y-axis may represent the reflectance rate (or level) of the electronic lens assembly 120. Using the values of B_{O}=0.35 and C=0.471, a plot of the reflectance function is shown as a curve 162.

FIG. 7 illustrates a logarithmic scale graph 170 of FIG. 6 in accordance with one or more embodiments of the present disclosure. The x-axis may represent the light intensity detected by the rear light sensor 116. The y-axis may represent the reflectance rate (or level) of the electronic lens assembly 120. By changing the scales of the plot shown in FIG. 6 to a log-log plot in FIG. 7, the curve 162 becomes a line 172.

A benefit of using the reflectance function per equation 1 is that a logarithmic-type of rear light sensor 116 together with a constant reflection ratio table results in the intended function. A table of reflectance as a function rear light sensor Lux may be arranged as constant reflectance ratios as shown in Table I below. The reflectance ratios between successive pairs of entries may be a constant and is decreasing in reflectance. The constant decreasing reflectance ratios may result in constant luminance ratios to the user 90, assuming the illumination falling on the electronic display mirror 100 is constant. This is helpful because the eye sees luminance ratios as linear increments in perceived brightness.

The perception of the human eye is to interpret luminance ratio steps as equal brightness changes. As an example, the eye perceives a luminance change from 1 candela per square meter (cd/m²) to 1.2 cd/m² (a ratio=1.2) as equal to a luminance change from 100 cd/m² to 120 cd/m². The nonlinear logarithmic response of the eye is what allows the visual system to work over many orders of magnitude.

Another benefit is that if a logarithmic type of rear light sensor 116 is used in conjunction with equal A/D increments for each dimming reflectance ratio step, as shown in Table I, the result is the function per equation 1. Therefore, an A/D resolution is not lost over more than 5 decades of illuminance on the rear light sensor 116.

FIG. 8 illustrates a graph 180 of the reflectance function under various ambient intensities in accordance with one or more embodiments of the present disclosure. The x-axis may represent the light intensity detected by the rear light sensor 116. The y-axis may represent the reflectance rate (or level) of the electronic lens assembly 120. The graph 180 generally sets B_{O}=0.7 and C=0.423, and shown at 20 points. The reflectance value R of the example ranges from 0.1 to 0.7. A reflectance value R of 1 means complete reflection.

A curve 182 may show the reflection function under the twilight ambient condition. The curve 182 may illustrate a gain factor value GF that has been adjusted to produce a negative index difference value −ΔN of minus ten steps. A curve 184 may show the reflection function under the dark ambient condition. The curve 184 may illustrate a gain factor value GF that has been adjusted to produce a negative index difference value −ΔN of minus five steps. A curve 186 may show the reflection function under the completely dark ambient condition. The curve 186 may illustrate a gain factor value GF that has been adjusted to produce a negative index difference value −ΔN of zero steps.

FIG. 9 illustrates a block diagram of an automatic dimming control system in accordance with one or more embodiments of the present disclosure. The automatic dimming control system may be implemented with components mounted on the printed wire board 124 and the electronic lens assembly 120. The rear light sensor 116 generally comprises a rear sensor 200 and a rear logarithmic amplifier 202. The ambient light sensor 129 generally comprises an ambient sensor 210 and an ambient logarithmic amplifier 212. The components on the printed wire board 124 that make up the control circuit may include the electrical interface 114, the slide control 130, a rear analog-to-digital converter 204, a reflection ratio table 206, a control loop 208 and an ambient analog-to-digital converter 214. The control loop 208 generally comprises a luminance ratio table 216, a first translate circuit 218, a second translate circuit 220, a third translate circuit 222, a first summation circuit 224, a second summation circuit 226 and a gain factor table 228.

The slide control 130 may generate and present a user bias value ΔN_{BD} to the reflection ratio table 206. The reflection ratio table 206 may implement a multidimensional table. An example implementation of three dimensions of the reflection ratio table 206 while in the mirror mode may be provided Table I as follows:

TABLE I

| N_{M} | R | 10-bit A/D |
|---|---|---|
| 0 | 0.70 | 23 |
| 1 | 0.58 | 123 |
| 2 | 0.47 | 223 |
| 3 | 0.39 | 323 |
| 4 | 0.32 | 423 |
| 5 | 0.26 | 523 |
| 6 | 0.22 | 623 |
| 7 | 0.18 | 723 |
| 8 | 0.15 | 823 |
| 9 | 0.12 | 923 |
| 10 | 0.10 | 1023 |

The reflectance ratio table 206 may present the reflectance value R, adjusted by the user bias value ΔN_{BD}, to the electronic lens assembly 120. Entries in the rear step value N_{M} column generally represent a sequence of integer values. Entries in the reflectance value R column may be determined per equation 5 as follows:

R=R_{M}^{(ΔN}^{_{BD}}^{-ΔN)}B_{OM}(LS_{REAR})^{-C}^{_{M}}, (5)
where: C_{M}=power constant (mirror mode); B_{OM}=offset constant (mirror mode); R_{M}=reflectance ratio (mirror mode); ΔN_{BD}=user bias value; and ΔN=index difference value.

The reflection ratio table 206 may present the A/D entries in a value A to the second translate circuit 220. The reflection ratio table 206 may also present the N_{M} entries in to the third translate circuit 222. The second translation circuit 220 may be operational to generate a first rear value B by a linear conversion of the A/D value by a parameter K_{A/D} per equation 6 as follows:

B=K_{A/D}×A/D_{REAR}, (6)
where the parameter K_{A/D} may be a constant.

The third translation circuit 222 may be operational to generate a second rear value D by a linear conversion of the N_{M} value based on parameters K₃ and K₄ per equation 7 as follows:

D=(K₃×N_{M})+K₄, (7)
where the parameters K₃ and K₄ may be constants.

The first summation circuit 224 may be operational to generate a translation value P_{T} by summing the first rear value B and the second rear value D. The second summation circuit 226 may be operational to generate a gain factor value GF based on the translation value P_{T}, an ambient value Q_{T} and a constant value K_{OFFSET}. The gain factor value GF may be the ambient value Q_{T} plus the constant value K_{OFFSET} minus the translation value P_{T}. In various embodiments, the constant value K_{OFFSET} may be 0.2982.

The luminance ratio table 216 may implement a multidimensional table. An example implementation of two dimensions of the luminance ratio table 216 while in the mirror mode may be presented in Table II as follows:

TABLE II

| N_{H} | 10-bit A/D |
|---|---|
| 0 | 23 |
| 1 | 123 |
| 2 | 223 |
| 3 | 323 |
| 4 | 423 |
| 5 | 523 |
| 6 | 623 |
| 7 | 723 |
| 8 | 823 |
| 9 | 923 |
| 10 | 1023 |

Entries in the ambient step value N_{H} column generally represent a sequence of integer values. The luminance ratio table 216 may present the ambient step entries N_{H} to the first translate circuit 218 in response to an ambient intensity sensed by the ambient light sensor 129. The ambient value Q_{T} may be determined by equation 8 as follows:

Q_{T}=(K₁×N_{H})+K₂, (8)
where the parameters K₁ and K₂ may be constants.

The gain factor table 228 may be operational to generate the negative index difference value −ΔN based on the gain factor value GF. An example implementation of the gain factor table 228 while in the mirror mode may be provided in Table III as follows:

TABLE III

| GF | −ΔN |
|---|---|
| 1 | 0 |
| 1.328803 | −1 |
| 1.765719 | −2 |
| 2.346293 | −3 |
| 3.117763 | −4 |
| 4.142894 | −5 |
| 5.505092 | −6 |
| 7.315185 | −7 |
| 9.720443 | −8 |
| 12.91656 | −9 |
| 17.16357 | −10 |

By starting with the constant mirror reflection rate ratio table 206 (e.g., Table I), the user 90 may modify the rear light sensor determined luminance by constant ratios per his/her preference. The modification is done by applying a user preferred number of “offset” steps (ΔN_{BD}) from the rear light sensor determined reflectance step number N_{M}. The user number of offset step value ΔN_{BD} may be applied to whatever reflectance step value N_{M} is determined by the rear light sensor 116.

The next aspect to consider is that the dimming reflection ratio as determined by the rear light sensor 116 may be modified by the light level that the user 90 is seeing out of the front windshield. As a surrounding “scene” becomes brighter out of the front windshield, the user 90 may desire a higher mirror reflectance rate as confirmed by FIG. 4. As shown in FIG. 4, as the “ambient” forward facing light increases, the reflection rate R should also increase.

The gain factor value GF increase is known to be a function according to the logarithm of the luminance ratio between the forward luminance divided by the luminance of emissive type displays. The gain factor value GF may be determined according to equation 9 as follows:

$$G F = 1.125 log ( \frac{FFVI}{WSI} ) + 0.2 \; 982 , \qquad ( 9 )$$

where: GF=Gain Factor; FFVI=Forward Field of View Intensity; WSI=Display White Stroke Intensity; and the value 0.2982 may be a unique constant for use in automatic luminance control that may be dependent on a number of characteristics of the vehicle, such as, but not limited to, vehicle configuration including window tint level, presence of a sunroof, and vehicle window size.

Modifying the emissive display concept for reflective displays provides that a luminance in cd/m2 is proportional to illuminance in Lux, and a mirror luminance seen by the user 90 is proportional to Illuminance x Reflection Rate. This gain factor value GF determination may be accomplished by the control loop 208 in FIG. 9. However, unlike automatic luminance control systems, the modified concept is that the luminance seen by the user 90 in the electronic display mirror 100 is proportional to the multiple of the mirror reflection rate and the rear illuminance on the electronic display mirror 100. The luminance seen by the user 90 is accomplished via the second translation circuit 220, the third translation circuit 222 and the first summation circuit 224. To understand the modified concept, the starting point is that the log of the luminance seen in the electronic display mirror 100 by the user 90 may be determined according to equation 10 as follows:

K×log(L_{SEL})=K×log(R×Lux_{Rear}), (10)
where: K=a constant that may be determined based on vehicle testing; L_{SEL}=a luminance drive value; and Lux_{REAR}=a rear light sensor value in Lux

Using the law of logarithms, equation 10 may be rewritten as equation 11 as follows:

K×log(L_{SEL})=K×log(R)+K×log(Lux_{Rear}) (11)

The first term, log(R), may be further simplified by starting with an assumption that the reflectance rate for each of the steps in Table I may be determined according to equation 12, which accounts for decreasing reflectance rates as the step number N increases, as follows:

$${R}_{S E L} = \frac{{R}_{Max}}{{[ \frac{{R}_{Max}}{{R}_{Min}} ]}^{( \frac{T - N}{T - 1} )}} , \qquad ( 12 )$$

where: R_{MAX}=Maximum reflectance rate; R_{MIN}=Minimum reflectance rate; T=Total number for reflectance steps; and N=Selected (by user) luminance step number.

According to one or more embodiments, the log(R) may be written as equation 13 following:

$$log ( R ) = log ( {R}_{Max} ) - log \{ {[ \frac{{R}_{Max}}{{R}_{Min}} ]}^{\frac{( T - N )}{( T - 1 )}} \} \qquad ( 13 )$$

Using the laws of logarithms, the equation 13 may be rewritten as equation 14 as follows:

$$log ( R ) = log ( {R}_{Max} ) - ( \frac{T - N}{T - 1} ) log ( \frac{{R}_{Max}}{{R}_{Min}} ) \qquad ( 14 )$$

Applying the distributive law to equation 14 results in equation 15 as follows:

$$log ( R ) = log ( {R}_{Max} ) - ( \frac{T}{T - 1} ) log ( \frac{{R}_{Max}}{{R}_{Min}} ) + ( \frac{N}{T - 1} ) log ( \frac{{R}_{Max}}{{R}_{Min}} ) ( 15 ) \qquad ( 15 )$$

Since R_{MAX}, R_{MIN} and T are constants according to how Table I is configured, equation 15 may be transformed into equation 16 as follows:

log(R)=K₃(N)+K₄ (16)

Equation 16 may be implemented by the third translation circuit 222. The third translation circuit 222 may be implemented with linear addition and subtraction. A direct consequence of setting up the reflectance steps as constant ratios may be considered implementing an exponential function.

According to one or more embodiments, the second term in equation 11 may be analyzed further. For example, if a logarithmic type of rear light sensor 116 is utilized, the analog-to-digital (A/D) converter 204 output values may be written according to equation 17 as follows:

$$A / D = ( \frac{{V}_{O}}{{V}_{S}} ) \times ( {2}^{B} - 1 ) , \qquad ( 17 )$$

where: A/D=an output count from the A/D converter; B=A/D resolution; V_{S}=A/D reference voltage; and V_{O}=an input voltage to A/D converter.

If a logarithmic light sensor, such as an OSRAM SFH 5711 light sensor, is utilized with a 10-bit A/D converter 204, equation 17 may be transformed as follows where Eᵥ is the illuminance Lux value:

$$A / D = ( \frac{1023}{3.3 V} ) ( \frac{{R}_{2}}{{R}_{1}} ) ( {R}_{2} + {R}_{1} ) ( 10 μ ) log ( \frac{{E}_{V}}{1} ) \qquad ( 18 )$$

Equation 18 may be simplified to equation 19 as follows:

A/D=K log(E_{V}) (19)

Using equation 19, the second term in equation 11 may be rewritten as equation 20 as follows:

K×log(Lux_{REAR})=K×A/D_{Count} (20)

Equation 20 may be implemented by the second translation circuit 220.

Use of a logarithmic light sensor may simplify the mathematics to linear addition and subtraction in the first summation circuit 224 and the second summation circuit 226. An additional benefit of using a constant reflectance ratio table with a logarithmic light sensor may be that each reflectance step may be associated with a constant delta increase in the A/D count. Therefore, the A/D resolution may not be lost as may occur if a linear light sensor were implemented as the rear light sensor 116 and/or the ambient light sensor 129. The multiplication shown in equation 10 to determine the reflected luminance to the user 90 may be accomplished by addition due to the reflectance ratio structure of entries in Table I and the use of logarithmic light sensors.

A design of the electronic display mirror 100 may account for a luminance ratio between the forward looking luminance seen by the user 90 looking out of the front windshield and the reflected mirror luminance. As luminance may be directly proportional to illuminance Lux, the gain factor GF of equation 9 may be adjusted where the gain factor GF is that the luminance seen by the user 90 on the electronic display mirror 100 due to rear illumination may be multiplied to account for a forward looking light adaptation factor. The adjusted gain factor GF may be determined per equation 21 as follows:

$$G F = {K}_{G} log ( \frac{L u {x}_{F orward}}{R \times {Lux}_{R e a r}} ) + {K}_{O f f s e t} , \qquad ( 21 )$$

where K_{G} is a constant.

The denominator term of the logarithm in equation 21 may be proportional to the luminance seen by the user 90 when looking at the electronic display mirror 100. Therefore, equation 21 may be rewritten as equation 22 as follows:

GF=K_{G} log(Lux_{Forward})+K_{G} log(R×Lux_{REAR})+K_{Offset} (22)

Development of the second term of equation 22 was mentioned above and may be implemented in the second translation circuit 220, the third translation circuit 222 and the first summation circuit 224. By utilizing a logarithmic type of ambient light sensor 129, the first term of the equation 22 may be a linear equation of the ambient step number N_{H} in Table II (the luminance ratio table 216). Therefore, by simple addition and subtraction in the second summation circuit 226, the gain factor value GF may be determined due to the use of logarithmic light sensors and a constant reflectance ratio table in conjunction with the negative fractional power per equation 1.

The negative fractional power dimming function and the negative delta step forward looking (facing) light sensor function may be used to control the reflectance of the electronic display mirror 100 during nighttime operation. Using the negative fractional power dimming function with logarithmic light sensors, both daytime automatic display luminance and nighttime automatic dimming control may be performed using the ambient (forward) light sensor 129 and the rear (rearward looking) light sensor 116. Additionally, the negative fractional power dimming function allows the incorporation of the user bias value ΔN_{BD} into the generation of the reflectance value R. The negative fractional power dimming function may also allow the association of equal A/D converter steps with successive automatic dimming ratio steps.

In various embodiments, the electronic display mirror 100 may provide an integrated solution that allows the user 90 to set a desired reflection rate preference that may not be based on a given operational set point. In other words, once the user 90 sets the user bias value ΔN_{BD}, a correct offset may be applied in a ratio manner such that all operational levels may have the desired and equal appearing bias to the user 90. In some embodiments, other linear and/or semi-linear light sensors with or without automatic gain ranging may be utilized with attention to the resolution at lower levels.

Increasing the reflected luminance of the electronic display mirror 100 to employ the gain factor value GF over a suitable range may be accomplished by using negative values in the index difference value ΔN. In order to increase the luminance gain of the mirror, assembly 100, the reflectance rate may be increased by going to lower step (or entry) values in the Table I (reflection ratio table 206). Doing so generally multiplies the luminance seen by the user 90 by the gain factor GF. As Table I may be arranged according to constant reflectance ratios between successive pairs of entries, a gain factor multiplication may be accomplished by offsetting the current reflectance step by ΔN steps per equation 23 as follows:

$$Δ N = \frac{ ln ( GF )}{ln ( {R}_{M} )} \qquad ( 23 )$$

The reflectance ratio R_{M} (mirror mode) may be determined by equation 24 as follows:

$${R}_{M} = {[ \frac{{R}_{Max}}{{R}_{Min}} ]}^{( \frac{1}{T - 1} )} \qquad ( 24 )$$

Note that the reflectance ratio R_{M} may be independent of a current operational step as determined by the rear light sensor 116 and/or the user bias value ΔN_{BD}. In various embodiments, equation 23 may be used to populate the entries in the Table III (the gain factor table 228) to present the negative difference value −ΔN in response to the gain factor value GF. A forward (ambient) looking to rear looking light sensor ratio may be used to change the offset factor within the control loop 208. Consider a case where the user bias value ΔN_{BD} is zero, if ΔN=2 the luminance offset constant Bo may be multiplied by the square of R_{M}, and so forth. The multiplication may be accomplished by adding ΔN to the current step due to the constant step ratio structure of Table I (the reflectance ratio table 206).

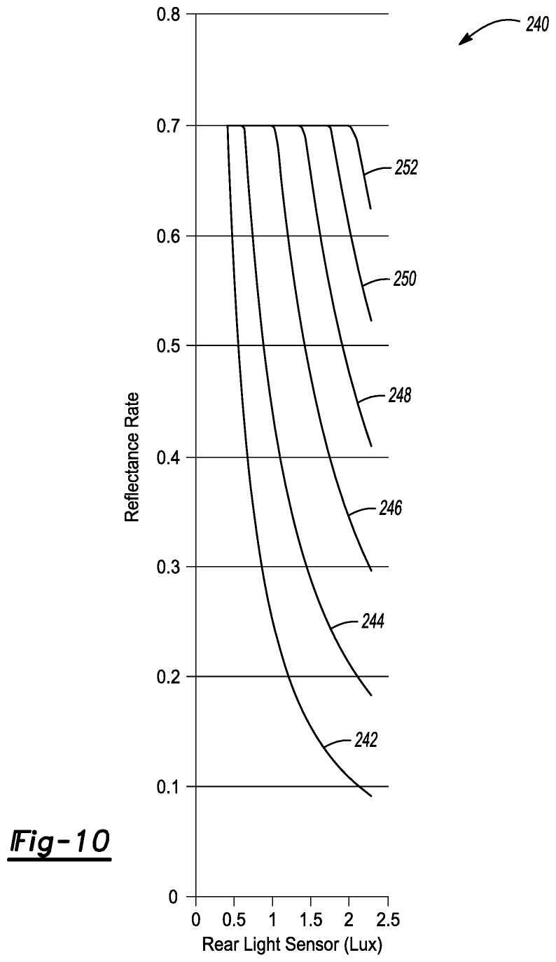

FIG. 10 illustrates a graph 240 of example reflectance rates for various forward-looking Lux values in accordance with one or more embodiments of the present disclosure. The x-axis of the graph 240 may represent a rear light sensor intensity (Lux). The y-axis of the graph 240 may represent a reflectance rate. As the ambient light sensor 129 measures higher Lux values, the reflectance rate determined by the rear light sensor 116 may increase, similar to the increase shown in FIG. 8. A curve 242 may illustrate an ideal response to the rear light sensor 116. Curves 244, 246, 248, 250 and 252 generally illustrate responses where LS_{REAR}=19.58 Lux, 9.31 Lux, 4.43 Lux, 2.10 Lux and 1.01 Lux, respectively.

The offset constant value B_{O} and the power constant value C may be determined from end point values entered into equation 1. A first set of end points may be R=0.7 and LS_{REAR}=0.4173. A second set of end points may be R=0.1 and LS_{REAR}=2.273. The first set and the second set of end points may produce equations 25 and 26 as follows:

0.7=B_{O}(0.4173)^{-C} (25)

0.1=B_{O}(2.273)^{-C} (26)

Dividing equation 25 by equation 26 results in equation 27 as follows:

$$\frac{0.7}{0.1} = \frac{0.417 {3}^{- C}}{2.27 {3}^{- C}} \qquad ( 27 )$$

Equation 27 may be manipulated to solve for parameters C and B_{O} in equations 28 and 29:

$$\begin{matrix}c = \frac{log ( \frac{0.7}{0.1} )}{log ( \frac{2.273}{0.417 \; 3} )} = 1.147995 & ( 28 ) \\ {B}_{O} = \frac{0.7}{0.417 {3}^{- C}} = 0.25 \; 667 & ( 29 )\end{matrix}$$

Therefore, the rear sensor function, without the application of the forward sensor gain factor adjustment, may be provided by equation 30 as follows:

R=0.25667(LS_{REAR})^{-1.147995} (30)

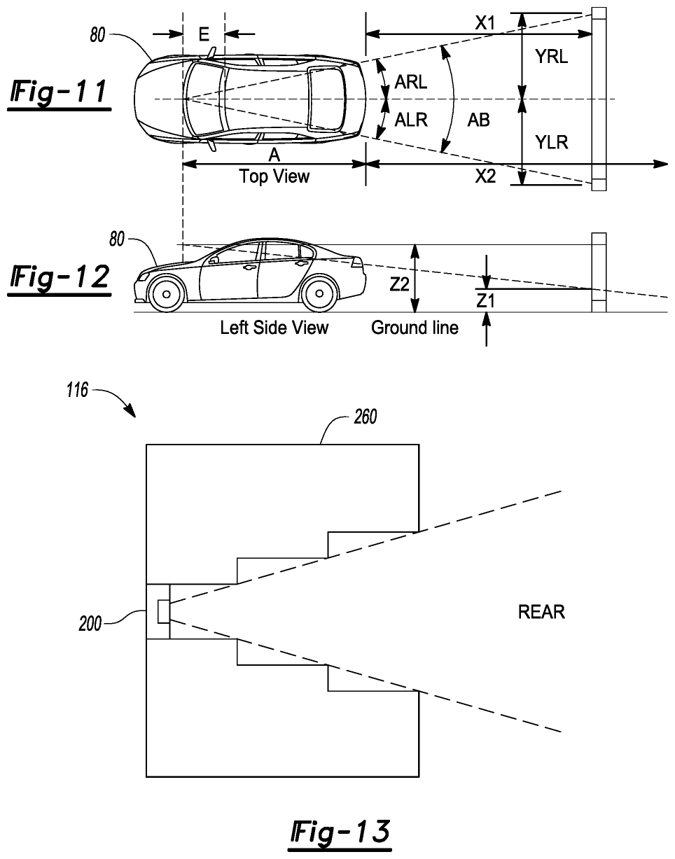

FIG. 11 illustrates a top view of a reflection view in accordance with one or more embodiments of the present disclosure. FIG. 12 illustrates a left side view of the reflection view in accordance with one or more embodiments of the present disclosure. The vehicle 80 may be resting on the ground. The reflection view may be seen by the user 90 through the electronic display mirror 100 and the rearview mirror of the vehicle 80.

FIG. 13 illustrates a cutaway view of a frustum 260 for a rear light sensor in accordance with one or more embodiments of the present disclosure. The frustum 260 may be part of the rear light sensor 116 and surround the rear sensor 200. The frustum 260 may be configured as a stepped pyramidal frustum such that the ambient light sensor may only detect the view as seen as a reflection by the user 90 from within the vehicle 80.

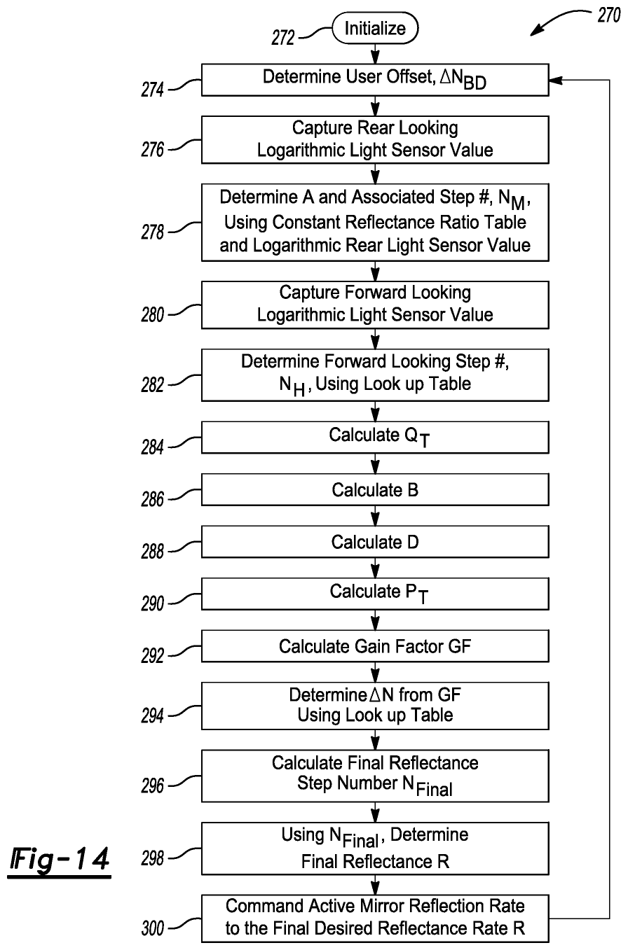

FIG. 14 illustrates a flow diagram of an example method 270 for automatic dimming in accordance with one or more embodiments of the present disclosure. The method (or process) 270 may be implemented by the electronic display mirror 100. The method 270 generally comprises a step 272, a step 274, a step 276, a step 278, a step 280, a step 282, a step 284, a step 286, a step 288, a step 290, a step 292, a step 294, a step 296, a step 298, and a step 300. The sequence of steps is shown as a representative example. Other step orders may be implemented to meet the criteria of a particular application.

In the step 272, the electronic display mirror 100 may be initialized. The user offset bias value ΔN_{BD} may be determined from the slide control 130 in the step 274. The rear light sensor 116 may capture a rear-looking logarithmic light intensity value in the step 276. In the step 278, the constant reflection ratio table 206 may determine the value A, the associated step number, the rear step value N_{M} and the reflectance value R in response to the rear-looking logarithmic light intensity, the user offset bias value ΔN_{BD} and the negative index difference value −ΔN.

In the step 280, the ambient light sensor 129 may capture an ambient (forward-looking) logarithmic light intensity value. The luminance ratio table 216 may determine an ambient step number N_{H} in the step 282 in response to the ambient logarithmic light intensity value. The first translate circuit 218 may calculate the ambient value Q_{T} in the step 284 based on the ambient step number N_{H}.

In the step 286, the second translate circuit 220 may calculate the value B in response to the value A. The third translate circuit 222 may calculate the value D in response to the rear step value N_{M} in the step 288. The value B and the value D may be summed in the first summation circuit 224 in the step 288 to calculate the translation value P_{T}. In the step 292, the second summation circuit 226 may calculate the gain factor value GF based on the translation value P_{T}, the ambient value Q_{T} and the constant value K_{OFFSET}.

In the step 294, the gain factor table 228 may determine the negative index difference value −ΔN in response to the gain factor value GF. The reflection ratio table 206 may use the negative index difference value −ΔN in the step 296 to update the rear step value N_{M} to a final step value (e.g., N_{FINAL}) as a sum of the rear step value N_{M}, the user bias value ΔN_{BD} and the negative index difference value −ΔN. In the step 298, the updated rear step value N_{M} may be used to update the reflectance value R. The updated reflectance value R may be transferred to the electronic lens assembly 120 in the step 300 to control the reflection rate at a final desired reflection rate. The method 270 may return to the step 274 to update the user bias value ΔN_{BD}. Thereafter, the method 270 may loop around again through the steps 274 to 300.

According to one or more embodiments, the auto dimming method for the electronic display mirror may include dual modes in the use of logarithmic light sensors to cover both daytime auto luminance and nighttime auto dimming functions. In such embodiments, the electronic display mirror may be configurable in the display mode to actively generate and present images to the user 90. The electronic display mirror may also be configurable in the mirror mode to reflect the taillights at an actively controlled reflection rate.

The electronic mirror may include a method of automatic display luminance that includes measuring a first logarithmic light luminance value using an ambient logarithmic light sensor. The method may include determining a first luminance value and an ambient step number using a constant luminance ratio look up table and the first logarithmic light intensity value with equal incremental values to yield a positive fractional power luminance function. A second logarithmic light intensity value may be measured using a forward-facing logarithmic light sensor. A forward step number may be determined using a forward look up table and the second logarithmic light intensity value with equal incremental values.

The method may include determining a scaled logarithmic forward field of view intensity value using a first gain constant, a second offset constant and the forward step number. A scaled logarithmic luminance intensity value may be determined using a fourth constant multiplied by a rear step number and added to a fifth constant. The method may include determining a gain factor based on the scaled logarithmic forward field of view intensity value and the first luminance value. A final luminance value may be determined by multiplying the first luminance value by the gain factor, wherein the electronic mirror is automatically dimmed based at least on the final luminance value.

The method may include determining the logarithmic rear luminance value by adding a user preference offset step value to the ambient step number. The gain factor may be determined from the sum of the negative scaled first logarithmic light intensity value and the scaled positive forward-looking step number. The method may include determining a positive offset value using the gain factor look up table and the gain factor. The value of the final luminance step may be determined by summing a luminance step number and the positive offset value. The method may also include determining the final luminance value using at least the final luminance step and the constant luminance ratio look up table.

While the control circuit (see FIG. 9) is operating in the display mode, the second translate circuit 220 and the first summation circuit 224 may be eliminated. The reflection ratio table 206 may be reconfigured (or replaced) with a multidimensional luminance ratio table. The gain factor table 228 may be reconfigured (or replaced) with another multidimensional gain factor table. The luminance ration table 216 may be reconfigured (or replaced) with another luminance ratio table.

An example implementation of three dimensions of the luminance ratio table 206 while in the display mode may be provided Table IV as follows:

TABLE IV

| N_{D} | L_{SEL} | 10-bit A/D |
|---|---|---|
| 0 | 38.71 | 23 |
| 1 | 50.00 | 123 |
| 2 | 64.58 | 223 |
| 3 | 83.41 | 323 |
| 4 | 107.72 | 423 |
| 5 | 139.13 | 523 |
| 6 | 179.69 | 623 |
| 7 | 232.08 | 723 |
| 8 | 299.74 | 823 |
| 9 | 387.13 | 923 |
| 10 | 500.00 | 1023 |

The luminance ratio table 206 may present a luminance value ESL (in place of the reflectance value R shown in FIG. 9) to the display 122.

An example implementation of the illuminance lookup table 216 while in the display mode may be provided in Table V as follows:

TABLE V

| N_{H} | 10-bit A/D |
|---|---|
| 0 | 23 |
| 1 | 123 |
| 2 | 223 |
| 3 | 323 |
| 4 | 423 |
| 5 | 523 |
| 6 | 623 |
| 7 | 723 |
| 8 | 823 |
| 9 | 923 |
| 10 | 1023 |

An example implementation of the gain factor lookup table 228 while in the display mode may be provided in Table VI as follows:

TABLE VI

| GF | ΔN |
|---|---|
| 1 | 0 |
| 1.328803 | 1 |
| 1.765719 | 2 |
| 2.346293 | 3 |
| 3.117763 | 4 |
| 4.142894 | 5 |
| 5.505092 | 6 |
| 7.315185 | 7 |
| 9.720443 | 8 |
| 12.91656 | 9 |
| 17.16357 | 10 |

In the display mode, the gain factor lookup table 228 may present the index difference value ΔN to the luminance ratio table 206 as a positive value (instead of a negative value as shown in FIG. 9).

The third translate circuit 222 may calculate the translation value P_{T} per equation 31 as follows:

P_{T}=(K₃×(N_{D}+ΔN_{BD}))+K₄, (31)
where: the parameters K₃ and K₄ may be constants; and N_{D} may be a display step number.

The luminance value ESL presented from the luminance ratio table 206 to the display 120 may be determined per equation 32 as follows:

ESL=R_{D}^{(ΔN}^{_{BD}}^{+ΔN)}B_{OD}(DBL)^{C}_{D}, (32)
where: ESL=Emitted Symbol Luminance in cd/m²; B_{OD}=offset constant (display mode); DBL=Display Background Luminance in cd/m²; and C_{D}=power constant (display mode).

One or more embodiments may include a non-transitory computer readable medium in the electronic display mirror 100 (e.g., on the printed wire board 124). The non-transitory computer readable medium may include program instructions that, when executed by a processor of the electronic display mirror 100, cause the processor to perform a process. As such, the processor may be coupled to the non-transitory computer readable medium. The process may include the steps used in the automatic dimming operations and/or the automatic luminance operations.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure.

What is claimed is:

1. An electronic mirror comprising:
an electronic lens assembly configured to reflect a light at a reflectance rate in response to a reflectance value;
a light sensor configured to generate an intensity value by logarithmic sensing the light proximate the electronic lens assembly;
an ambient light sensor configured to generate an ambient intensity value by logarithmic sensing an ambient light; and
a control circuit configured to generate the reflectance value in response to the ambient intensity value and the intensity value while in a mirror mode, wherein the reflectance value adjusts the reflectance rate of the electronic lens assembly with a negative fractional power of the intensity value.

2. The electronic mirror according to claim 1, further comprising a bias sensor connected to the control circuit, and configured to generate a bias value in response to a manual input from a user, wherein the reflectance value is generated in further in response to the bias value.

3. The electronic mirror according to claim 2, wherein the control circuit comprises a reflection ratio table having a plurality of entries configured to control the reflectance value in response to the bias value and the rear intensity value.

4. The electronic mirror according to claim 3, wherein a reflectance ratio between successive pairs of the plurality of entries is a constant.

5. The electronic mirror according to claim 3, wherein the control circuit further comprises a control loop configured to generate an index difference value in response to the ambient intensity value, the reflection ratio table presents the reflectance value in further response to the index difference value, and an increase in an amplitude of the index difference value results in a shift to a lower value among the plurality of entries in the reflection ratio table to increase a reflection rate of the electronic lens assembly.

6. The electronic mirror according to claim 5, wherein the reflection ratio table is further configured to present a gain value to the control loop in response to the rear intensity value, and the index difference value is responsive to the gain value.

7. The electronic mirror according to claim 1, wherein the electronic lens assembly is configured to generate a reflected light from the rear light, and a reflected luminance of the reflected light is proportional to a product of an incident luminance of the rear light and a reflection rate.

8. The electronic mirror according to claim 1, further comprising a display configured to present a visual image, wherein the control circuit is further configured to adjust a luminance of the visual image with a positive fractional power of the ambient intensity value while in a display mode.

9. An electronic display mirror comprising:
a housing attachable to a vehicle, and having an open side;
an electronic lens assembly disposed in the housing facing the open side, and configured to reflect a rear light incident on the open side at a reflectance rate in response to a reflectance value;
a rear light sensor attached to the housing facing the open side, and configured to generate a rear intensity value by logarithmic sensing the rear light proximate the electronic lens assembly;
an ambient light sensor attached to the housing facing away from the open side, and configured to generate an ambient intensity value by logarithmic sensing an ambient light; and
a control circuit disposed in the housing, and configured to generate the reflectance value in response to the ambient intensity value and the rear intensity value, wherein the reflectance value adjusts the reflectance rate of the electronic lens assembly with a negative fractional power of the rear intensity value.

10. The electronic display mirror according to claim 9, further comprising a bias sensor attached to the housing, connected to the control circuit, and configured to generate a bias value in response to a manual input from a user, wherein the reflectance value is generated in further in response to the bias value.

11. The electronic display mirror according to claim 10, wherein the control circuit comprises a reflection ratio table having a plurality of entries configured to control the reflectance value in response to the bias value and the rear intensity value.

12. The electronic display mirror according to claim 11, wherein a reflectance ratio between successive pairs of the plurality of entries is a constant.

13. The electronic display mirror according to claim 11, wherein the control circuit further comprises a control loop configured to generate an index difference value in response to the ambient intensity value, the reflection ratio table presents the reflectance value in further response to the index difference value, and an increase in an amplitude of the index difference value results in a shift to a lower value among the plurality of entries in the reflection ratio table to increase a reflection rate of the electronic lens assembly.

14. The electronic display mirror according to claim 13, wherein the reflection ratio table is further configured to present a gain value to the control loop in response to the rear intensity value, and the index difference value is responsive to the gain value.

15. The electronic display mirror according to claim 9, wherein the electronic lens assembly is configured to generate a reflected light from the rear light, and a reflected luminance of the reflected light is proportional to a product of an incident luminance of the rear light and a reflection rate.

16. A non-transitory computer readable medium on which is recorded instructions, executable by a processor, for controlled dimming of an electronic mirror, wherein execution of the instructions causes the processor to:
receive an intensity value from a light sensor, wherein the light sensor is configured to generate the intensity value by logarithmic sensing a light;
receive an ambient intensity value from an ambient light sensor, wherein the ambient light sensor is configured to generate the ambient intensity value by logarithmic sensing an ambient light;
generate a reflectance value in response to the ambient intensity value and the intensity value while in a mirror mode; and
transfer the reflectance value to an electronic lens assembly, wherein the reflectance value adjusts a reflectance rate of the electronic lens assembly with a negative fractional power of the intensity value.

17. The non-transitory computer readable medium according to claim 16, wherein the execution of the instructions further causes the processor to:
receive a bias value from a bias sensor, wherein the bias sensor is configured to generate the bias value in response to a manual input from a user, and the reflectance value is generated in further in response to the bias value.

18. The non-transitory computer readable medium according to claim 17, wherein the instructions include a reflection ratio table having a plurality of entries configured to control the reflectance value in response to the bias value and the intensity value, and a reflectance ratio between successive pairs of the plurality of entries is a constant.

19. The non-transitory computer readable medium according to claim 18, wherein the execution of the instructions further causes the processor to:
generate an index difference value in response to the ambient intensity value, wherein the reflection ratio table presents the reflectance value in further response to the index difference value, and an increase in an amplitude of the index difference value results in a shift to a lower value among the plurality of entries in the reflection ratio table to increase a reflection rate of the electronic lens assembly.

20. The non-transitory computer readable medium according to claim 16, wherein the execution of the instructions further causes the processor to:
generate a luminance value in response to the ambient intensity value and the intensity value while in a display mode; and
transfer the luminance value to a display, wherein the luminance value adjusts a luminance of a visual image presented by the display with a positive fractional power of the ambient value.
